(19) United States
(12) Patent Application Publication
(10) Pub. No.: US 2007/0204852 A1
(43) Pub. Date: Sep. 6, 2007

(54) Infrared deck ovens

(76) Inventor: Kevin Cohen, Englewood, CO (US)

Correspondence Address: KOLISCH HARTWELL, P.C., 200 PACIFIC BUILDING, 520 SW YAMHILL STREET, PORTLAND, OR, 97204, US

(21) Appl. No.: 11/523,761

(22) Filed: Sep. 18, 2006

Related U.S. Application Data
(60) Provisional application No. 60/718,209, filed on Sep. 16, 2005.

(51) Int. Cl. F24C 15/34; A21B 1/04

(52) U.S. Cl. 126/273.5

(57) ABSTRACT

This disclosure describes deck ovens including a cooking chamber, a heating chamber beneath the cooking chamber, a cooking surface between the heating and cooking chamber, and an infrared heating element in the heating chamber. It further describes a kit for retrofitting a deck oven to include an infrared heating element including a gas-fired infrared heating element, piping to bring the heating element in fluid communication with a gas supply, a mounting frame to secure the heating element in place, a mounting bracket to secure the heating element to the mounting frame, and an anchor bracket to secure the mounting frame to the heating chamber. Also described is a method for cooking food items including selecting a desired temperature range, emitting infrared radiation towards a cooking surface, and measuring the air temperature inside a cooking chamber.

### RELATED APPLICATIONS

This application claims priority under 35 U.S.C. § 119(e) to U.S. Provisional Application No. 60/718,209 filed on Sep. 16, 2005, the disclosure of which is incorporated herein by reference for all purposes.

### BACKGROUND

Ovens suitable for restaurant and other high-use services typically use oxygen burning heating elements, such as gas or wood burning heating elements. The heating elements are sometimes disposed within the same chamber as the food item to be heated and other times are not readily accessible. To prevent scorching and to evenly distribute heat, the food item is sometimes set on a rotating platform. These oxygen burning heating elements take significant time to provide sufficient heat within the chamber and typically do not maintain a particular temperature when the chamber door is opened to insert or remove the food item. Moreover, the requisite heating time may need to be adjusted to account for different altitudes.

Examples of ovens suitable for restaurant and other high-use services are found in U.S. Pat. Nos. 2,860,225, 3,155,814, 3,313,917, 3,552,299, 3,626,155, 4,238,669, 4,305,329, 4,934,260, 4,951,648, 5,036,179, 5,039,535, 5,378,872, 5,454,295, 5,492,055, 5,560,285, 5,605,092, 5,653,905, 5,872,351, and 6,146,677, 6,250,210, 6,307,185, and 6,670,586 the disclosures of which are incorporated herein by reference for all purposes.

### BRIEF DESCRIPTION OF THE DRAWINGS

FIG. 1 is a perspective view of a deck oven.

FIG. 2 is a front view of a heating chamber having traditional gas-fired burner heating elements.

FIG. 3 is a front view of a heating chamber of a deck oven having an infrared heating element.

FIG. 4 is a perspective view of a kit for retrofitting a traditional gas-fired burner deck oven with an infrared heating element.

FIG. 5 is a top view of various infrared heating element configurations that may be used inside the oven of the present disclosure.

FIG. 6 is a block diagram depicting a method of cooking a food item in an oven with an infrared heating element.

### DETAILED DESCRIPTION

The present disclosure describes a deck oven having an infrared heating element positioned below a floor or deck in a cooking chamber. The disclosure also describes a kit for retrofitting a traditional deck oven, replacing a gas-fired burner heating element with an infrared heating element. The disclosure also describes a method of cooking a food item in a deck oven equipped with an infrared heating element.

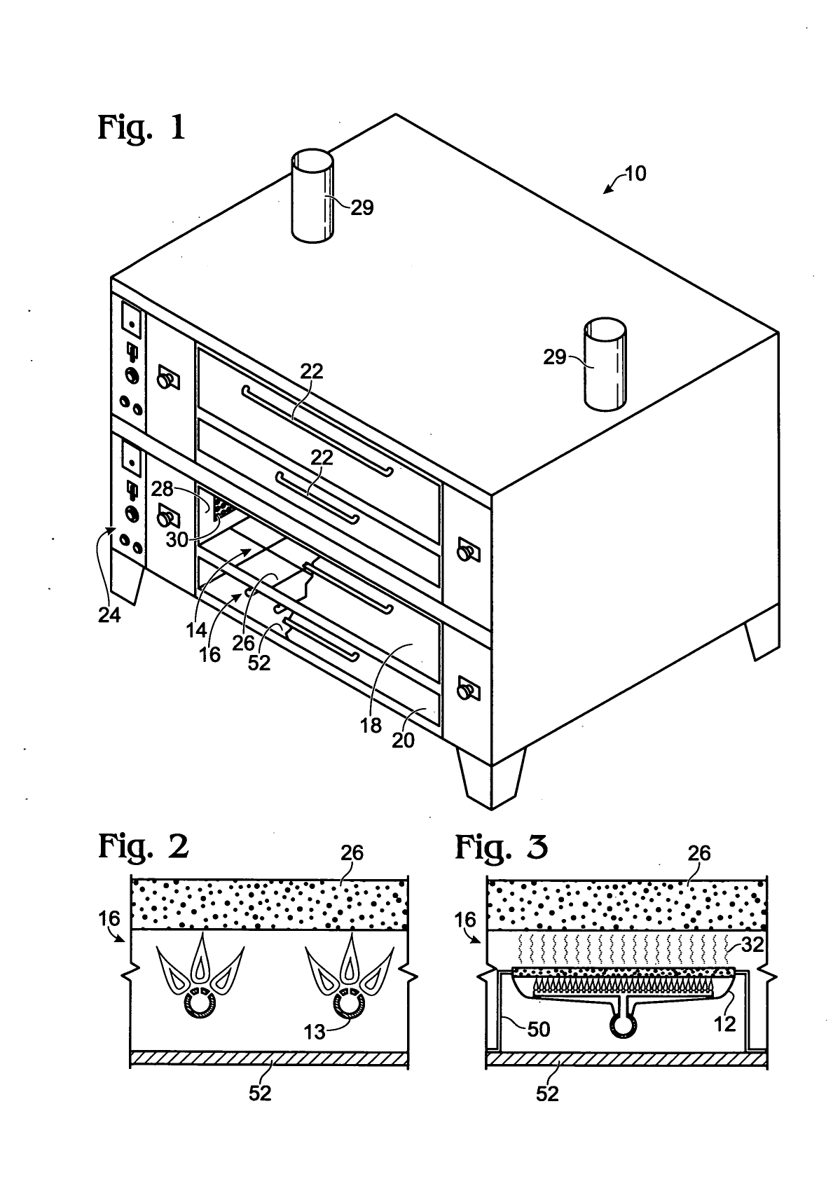

As shown in FIG. 1, deck oven 10 has cooking chamber 14 above heating chamber 16 for cooking food items, such as pizza. Deck ovens provide certain cooking qualities compared to other types of ovens, such as rotary ovens, conveyor ovens, and impingement ovens. One illustrative and non-exclusive example of a conventional deck oven is the Super Deck 6, Y-600 gas deck oven manufactured by Baker's Pride of New Rochelle, N.Y.

As shown in FIG. 1, deck oven 10 includes separate doors 18 and 20 for cooking chamber 14 and heating chamber 16, respectively. Both doors may be pivotally mounted to their respective chambers such that a user may gain access to the chambers by pivoting the doors downward. Handles 22 may be provided on the doors to facilitate their manipulation.

Exterior controls 24 for operating deck oven 10 are provided adjacent the doors. Typical controls may include a thermostat for setting a desired cooking chamber temperature, an on/off switch for selectively supplying gas to a heating element, and a pilot light control knob among other control options.

Cooking chamber 14 is an enclosed and insulated chamber configured to store heat therein for cooking food items. Cooking chamber 14 includes a bottom cooking surface 26, sidewalls 28, and an upper surface (not pictured). Vent holes 30 may be provided for bringing cooking chamber 14 into fluid communication with heating chamber 16, such as through flues 29 extending to heating chamber 16.

Cooking surface 26 supports a food item as it cooks in cooking chamber 14. Cooking surface 26 may be formed from brick, stone, ceramic, or other opaque material that is capable of withstanding a high temperature environment without burning. An example of such a ceramic material is cordierite (magnesium aluminum silicate). Cooking surface 26 may be removable, such as for ease of cleaning, or it may be integrally formed within cooking chamber 14. For example, cooking surface 26 may be divided into a number of individually removable tiles such as shown in FIG. 1. Cooking surface 26 may also form a top edge of heating chamber 16.

As shown in FIG. 3, cooking surface 26 is heated from below by infrared heating element 12 mounted in heating chamber 16. Heating chamber 16 may be an insulated and enclosed chamber having flues to transfer heated air to cooking chamber 14. Infrared heating element 12 may be advantageously mounted between 4 and 6 inches beneath cooking surface 26 to avoid burning or scorching cooking surface 26. However, different mounting heights may be used, such as between 2 and 8 inches or even closer or farther from cooking surface 26.

Infrared heating element 26 supplies heating energy by emitting infrared radiation 32 onto an underside of cooking surface 26. In the example shown in FIG. 3, cooking surface 26 is an opaque surface that absorbs infrared radiation 32 and converts it into heat. The heated cooking surface 26 in turn transfers it's heat energy via conduction to food items resting on cooking surface 26 and to the air inside cooking chamber 14 in contact with cooking surface 26. The heated air inside cooking chamber 14 in turn transfers heat to food items via convection. Similarly, the air inside heating chamber 16 is heated by the underside of the heated cooking surface 26 in addition to any heating provided by infrared heating element 26 itself, for example, from the combustion of gas in a gas-fired infrared heating element.

Infrared heating element 12 may be selected such that it provides sufficient heating without the need for supplemental heating devices. For instance, in the example provided in FIG. 3, infrared heating element 12 provides all the heat energy necessary to bring cooking chamber 14 to a desired temperature and to cook food items by both conduction and natural convection from the heated air inside cooking chamber 14. In some examples, a blower may be employed to further cook food items by forced convection.

While it is within the scope of this disclosure that infrared heating elements may be mounted inside a cooking chamber to emit infrared radiation directly at food items, a preferred embodiment attains satisfactory heating and cooking solely with infrared heating from below cooking surface 26. Similarly, while an infrared heating element could be used merely to provide supplemental heat to a cooking surface in conjunction with another primary heating source, such as wood burning fire or gas-fired burners, the preferred embodiment utilizes infrared radiation directed to an underside of a cooking surface as the sole source of oven heating.

Infrared heating element 12 may be a gas-fired infrared heating element. However, other infrared heating elements, such as, for example, electrical resistance infrared heating elements may be used additionally or alternatively to gas-fired infrared heating elements. A gas-fired infrared heating element 12 typically combusts a gas at or near an emitter, a material that emits infrared radiation when heated. For example, ceramic materials typically emit significant amounts of infrared radiation when heated between approximately 1700 and 1850 degrees Fahrenheit. Additionally or alternatively to ceramic emitters, wire mesh emitters may be used. Suitable gas-fired infrared heating elements include the JFS 322-1000 and JFS 522-1000 burners manufactured by JF Swinehart Co., Inc. of Fostoria, Ohio.

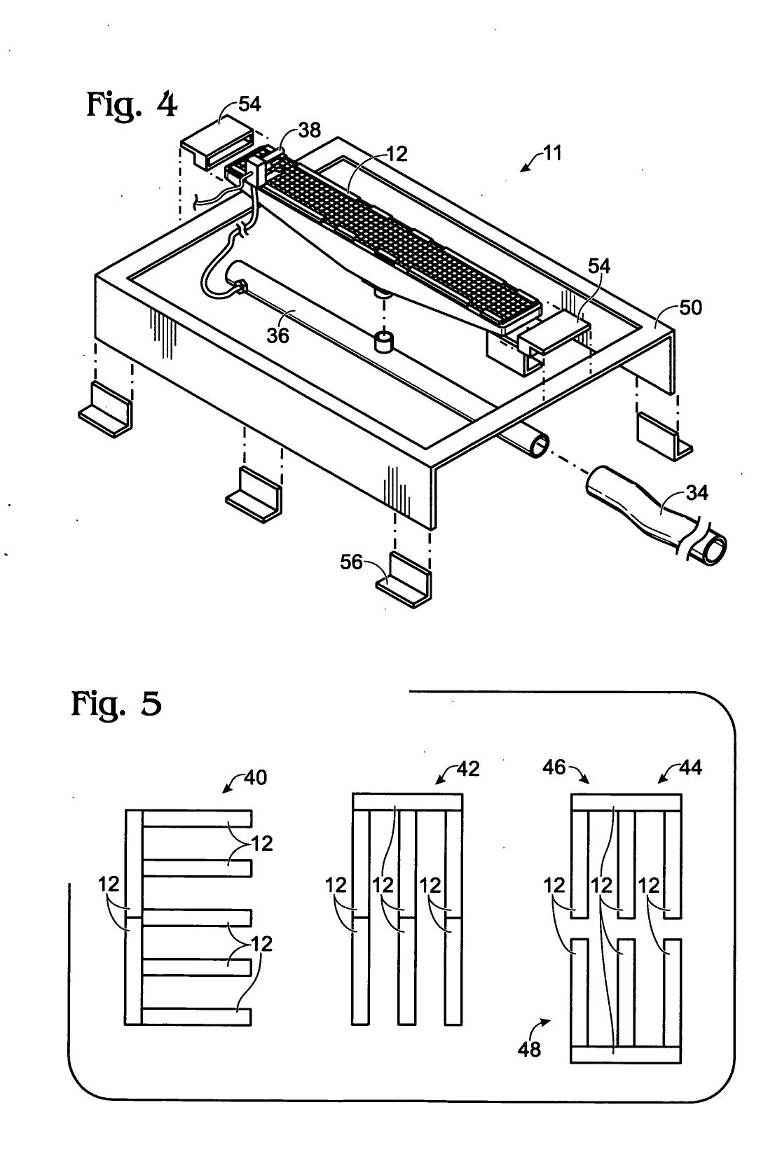

Heating chamber 16 typically includes a supply of combustible gas from an external source, which combusts in infrared heating element 12 to produce infrared radiation 32. In the example shown in FIG. 4, piping 34 and manifolds 36 bring gas-fired infrared heating element 12 into fluid communication with the external supply line of combustible gas.

Gas-fired infrared heating element 12 typically includes an ignition device 38 to ignite the combustible gas supplied thereto. Ignition device 38 may include a pilot light having it's own supply of combustible gas in combination with a thermocouple for regulating the supply of gas. In some examples, additional, alternative, or no gas regulation devices like a thermocouple may be employed in conjunction with a pilot light. Further, ignition device 38 may utilize an alternative to a pilot light, such as an electric arc ignition device. When multiple gas-fired infrared heating elements 12 are employed in a spaced apart fashion, a line lighter may be included to ignite gas-fired infrared heating elements not having their own ignition device 38.

As shown in FIG. 5, arrays of infrared heating elements may be employed in different configurations to provide a desired amount of heating energy over a certain cooking surface area. In the examples shown in FIG. 5, cooking surface 26 of deck oven 10 has a length of approximately 60 inches and a width of approximately 36 inches. The heating element arrays shown in FIG. 5 reduce hot and cold spots on cooking surface 26 due to the combination of their footprints, energy production relative to the size of the cooking surface 26 area, and orientations of the individual heating elements 26.

For example, a first array 40 employs 7 burners in a footprint of approximately 45 inches by 25 inches, with approximately 7.25 inches between each of the 5 spaced apart heating elements. First array 40 may include a single ignition device, and it is capable of producing approximately 70,000 BTU/hr.

Second array 42 employs 7 heating elements 26 in a footprint of approximately 47 inches by 22 inches with approximately 6.5 inches between the three rows of heating elements. One ignition device may be used to ignite all heating elements 12. Second array 42 is capable of producing approximately 70,000 BTU/hr.

Third array 44 utilizes 8 heating elements arranged in two sub-arrays, a first sub-array 46 and a second sub-array 48, as shown in FIG. 5. Because first sub-array 46 is spaced apart from second sub-array, either two ignition devices, one for each sub-array, or one ignition device and a line lighter extending between the sub-arrays are employed. Third array 44 has a total footprint of between approximately 50 and 60 inches by 22 inches. The total heating energy produced by heating elements 12 in third array 44 is approximately 80,000 BTU/hr.

Infrared heating element 12 may mount to a mounting frame 50 secured to a bottom surface 52 of heating chamber 16. Mounting frame 50 may be a bended metal frame as shown in FIG. 4. Mounting frame 50 may be any support member configured to support infrared heating element 12 in a desired orientation, such as between 4 and 6 inches beneath cooking surface 26. A variety of Flexistrut™ brand support members may be suitable for this purpose. Mounting brackets 54 are typically provided for securing infrared heating element 12 to mounting frame 50 and anchor brackets 56 are typically provided for securing mounting frame 50 to bottom surface 52, such as with screw fasteners. Mounting frame 50 may be sized to support multiple infrared heating elements 12 and multiple mounting frames 50 may be used.

Kit 11 for retrofitting a traditional deck oven having a traditional gas-fired burner 13 (FIG. 2) is depicted in FIG. 4. Kit 11 may include a plurality of infrared heating elements 12, such as gas-fired infrared heating elements. Different examples of kit 11 may be designed to create different configurations of infrared heating elements 12, such as the various arrays shown in FIG. 5.

A plurality of mounting brackets 54 are included to secure infrared heating elements 12 to the included mounting frame 50. Mounting frame 50 may be selected to position infrared heating elements 12 between 4 and 6 inches from cooking surface 26 of deck oven 10. Further, kit 11 includes a plurality of anchor brackets 56 for securing mounting frame 50 to a surface of heating chamber 16, such as, for example, bottom surface 52.

Kit 11 includes piping 34 and manifolds 36 for bringing the plurality of gas-fired infrared heating elements 12 into fluid communication with an existing supply of combustible gas. Ignition device 38, such as a pilot light or an electrical arc igniter, may be included in kit 11. In some examples, kit 11 includes ignition device 38 having a thermocouple or other gas regulation device. Suitable packaging for housing each component of kit 11 safely and economically may also be selected.

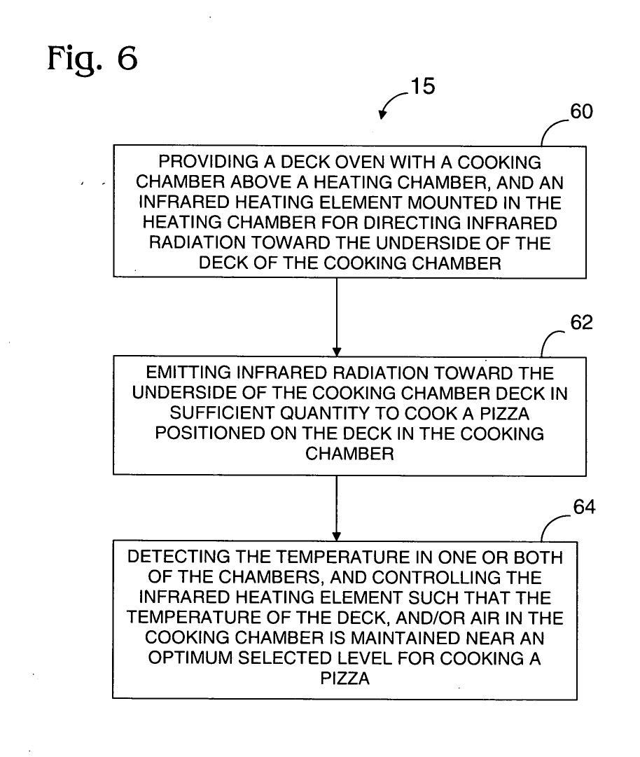

A method for cooking a food item in a deck oven with an infrared heating element is schematically depicted in FIG. 6. The method includes providing 60 a deck oven, such as described above, with an infrared heating element in a heating chamber. Further, the method includes emitting 62 infrared radiation towards the underside of the deck in sufficient quantity to cook a food item, for example pizza. The infrared heating element used to emit infrared radiation may be a gas-fired infrared heating element or it may be an electrical resistance infrared heating element.

Moreover, the method for cooking a food item may include controlling 64 the infrared heating element to maintain an oven temperature conducive to cooking a food item, for example maintaining the temperature near an optimum selected level for cooking a pizza. In some examples, the temperature in one of the chambers is detected and in other examples the temperature of both of the chambers is detected. Temperature detection may include measuring the temperature of the air inside the chamber or measuring the surface temperature of the deck.

While embodiments of infrared deck ovens and infrared heater retrofit kits, and methods of heating a cooking chamber have been particularly shown and described, many variations may be made therein. This disclosure may include one or more independent or interdependent inventions directed to various combinations of features, functions, elements and/or properties, one or more of which may be defined in the following claims. Other combinations and sub-combinations of features, functions, elements and/or properties may be claimed later in this or a related application. Such variations, whether they are directed to different combinations or directed to the same combinations, whether different, broader, narrower or equal in scope, are also regarded as included within the subject matter of the present disclosure. The foregoing embodiments are illustrative, and no single feature or element, or combination thereof, is essential to all possible combinations that may be claimed in this or a later application. Each claim defines an invention disclosed in the foregoing disclosure, but any one claim does not necessarily encompass all features or combinations that may be claimed.

Where the disclosure recites “a” or “a first” element or the equivalent thereof, such recitations include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

Inventions embodied in various combinations and subcombinations of features, functions, elements, and/or properties may be claimed through presentation of claims in a related application. Such claims, whether they are directed to different inventions or directed to the same invention, whether different, broader, narrower or equal in scope to the other claims, are also regarded as included within the subject matter of the present disclosure.

I claim:

1. A deck oven comprising:
a cooking chamber for cooking food items;
a heating chamber beneath the cooking chamber for heating the cooking chamber;
a deck for supporting food items in the cooking chamber, the deck having an underside and forming a bottom of the cooking chamber and a top of the heating chamber; and
an infrared heating element disposed in the heating chamber and configured to emit infrared radiation towards the underside of the deck, the infrared heating element providing at least a substantial majority of the heating in the cooking chamber.

2. The deck oven of claim 1, wherein the cooking chamber and the heating chamber each include pivotally mounted access doors.

3. The deck oven of claim 1, wherein the deck is comprised of one of brick, stone, or a ceramic material.

4. The deck oven of claim 1, wherein at least a portion of the deck is configured for removal from the cooking chamber.

5. The deck oven of claim 1, wherein the infrared heating element includes a gas-fired infrared heating element.

6. The deck oven of claim 5, wherein the infrared heating element utilizes atmospheric air as an oxidant.

7. The deck oven of claim 5, wherein the infrared heating element includes an array of gas-fired infrared heating elements.

8. The deck oven of claim 7, wherein the array comprises three spaced apart infrared heating elements aligned in parallel, with a transversely aligned fourth infrared heating element aligned along a terminal edge of each of the three infrared heating elements aligned in parallel.

9. The deck oven of claim 1, further comprising a flue between the heating chamber and the cooking chamber configured to permit passage of heated air from the heating chamber to the cooking chamber.

10. The deck oven of claim 1, further comprising a temperature sensing device mounted in one of the heating chamber and the cooking chamber.

11. A kit for retrofitting a deck oven to include an infrared heating element, the deck oven comprising a separately accessible cooking chamber for cooking a food item, a separately accessible heating chamber below the cooking chamber for housing the infrared heating element, and a shared deck for supporting a food item, the shared deck defining a bottom of the cooking chamber and a top of the heating chamber, comprising:
a gas-fired infrared heating element;
piping to bring the gas-fired infrared heating element into fluid communication with a gas supply; and
a fastener to fasten the gas-fired infrared heating element to the heating chamber.

12. The kit of claim 11, wherein the fastener includes a mounting frame to secure the gas-fired infrared heating element in a desired position within the heating chamber.

13. The kit of claim 12, further comprising:
a mounting bracket to secure the gas-fired infrared heating element to the mounting frame; and
an anchor bracket to secure the mounting frame to the heating chamber.

14. The kit of claim 12, wherein the desired position is between 4 and 6 inches beneath the shared deck.

15. The kit of claim 11, further comprising an ignition device for igniting the gas-fired infrared heating elements.

16. The infrared heating element kit of claim 15, wherein the ignition device includes a pilot light and a thermocouple.

17. The infrared heating element kit of claim 11 comprising a plurality of gas-fired infrared heating elements

18. The infrared heating element kit of claim 17, further comprising an ignition device for igniting one of the gas-fired infrared heating elements of the plurality of gas-fired infrared heating elements and a line lighter device for igniting the remaining gas-fired infrared heating elements.

19. The infrared heating element kit of claim 17, further comprising an ignition device for each of the plurality of gas-fired infrared heating elements.

20. A method of cooking a food item in a deck oven with an infrared heating element comprising the steps of:
providing a deck oven comprising a separately accessible cooking chamber for cooking a food item, a separately accessible heating chamber below the cooking chamber for housing the infrared heating element, and a shared deck for supporting a food item, the shared deck having an underside and defining a bottom of the cooking chamber and a top of the heating chamber; and
emitting infrared radiation towards the underside of the shared deck with the infrared heating element.

21. The method of claim 20, further comprising the steps of:
selecting a desired temperature range for the cooking chamber;
measuring the air temperature inside the cooking chamber to determine an actual temperature; and
stopping the emission of radiation of towards the underside of the shared deck when the actual temperature is within the desired temperature range.

22. The method of claim 21, further comprising the step of maintaining the desired cooking chamber temperature range by emitting radiation towards the underside of the cooking surface when the actual cooking chamber temperature drops below the desired cooking temperature range.

23. The method of claim 20, wherein emitting radiation towards the underside of the shared deck with an infrared heating element includes heating a material until it emits infrared radiation by burning a combustible gas.
